(19) United States
(12) Patent Application Publication
(10) Pub. No.: US 2026/0079073 A1
(43) Pub. Date: Mar. 19, 2026

(54) Global Skin Friction and Surface Pressure Measurements Using a Global Luminescent Oil-Film (GLOF) Skin Friction Meter

(71) Applicant: Board of Trustees of Western Michigan University, Kalamazoo, MI (US)

(72) Inventors: David Moussa Salazar, Kalamazoo, MI (US); Tianshu Liu, Portage, MI (US); Brian Montgomery, Kalamazoo, MI (US)

(21) Appl. No.: 19/329,525

(22) Filed: Sep. 15, 2025

Related U.S. Application Data
(60) Provisional application No. 63/694,794, filed on Sep. 13, 2024.

(51) Int. Cl. G01M 9/06; G01B 11/06; G01M 9/04; G06T 7/90

(52) U.S. Cl. CPC G01M 9/067; G01B 11/0658; G01M 9/04; G06T 7/90; G06T 2207/10024; G06T 2207/10064

(57) ABSTRACT

Aspects of the present disclosure may include systems and methods for assessing high resolution surface pressure fields generated by air moving across at least a portion of a bluff body, the method including covering the at least a portion of the surface of the bluff body with a layer of oil film comprising a luminescent dye; placing the bluff body in moving air with a constant velocity; assessing the luminescence of the dye in at least two consecutive time periods, wherein the luminescence of the dye is related to the thickness of the oil film at one or more locations on the surface of the bluff body.

### CROSS REFERENCE TO RELATED APPLICATIONS

The present application claims priority to U.S. Provisional Application No. 63/694,794, filed Sep. 13, 2024, the contents of which are incorporated by reference in their entirety.

### BACKGROUND OF THE INVENTION

The following document describes embodiments and aspects of global luminescent oil-film (GLOF) skin friction meter for the extraction of high resolution skin friction and surface pressure fields on buildings and other applications. By using the relation between skin friction and oil-film thickness given by the thin oil-film equation, combined with a variational formulation, embodiments and aspects of the Global Luminescent Oil-Film (GLOF) skin friction meter is able to extract high resolution global skin friction fields. Next, using the relation between surface pressure and skin friction given by the Navier-Stokes (NS) equations, a variational formulation is applied to extract surface pressure from the skin friction fields obtained using the GLOF technique.

In order to demonstrate the effectiveness of the proposed approach, global skin friction and surface pressure measurements were conducted on a generic low-rise building model using the Advanced Design Wind Tunnel (ADWT) at Western Michigan University's Applied Aerodynamics Laboratory (AAL). Testing was performed at a freestream velocity of 20 m/s corresponding to a Reynold number Re_{L} of 2.43×10⁵. Skin friction and surface pressure data were collected from the ground, sides, and top sections of the model.

Embodiments and aspects presented herein provide an exceptional alternative for the image-based measurement of global skin friction and surface pressure fields on buildings, which compared to currently available techniques, are capable of extract high spatial resolution results (about one data point per pixel), which offers a significant advantage when studying flow structures and topological features (i.e. flow separation and/or reattachment) around buildings. This combined data can be used to further understand aerodynamic forces and wind loads acting on a building at any moment.

### SUMMARY OF THE INVENTION

Aspects of the present disclosure may include a method for assessing high resolution surface pressure fields generated by air moving across at least a portion of a bluff body, the method including covering the at least a portion of the surface of the bluff body with a layer of oil film comprising a luminescent dye; placing the bluff body in moving air with a constant velocity; assessing the luminescence of the dye in at least two consecutive time periods, wherein the luminescence of the dye is related to the thickness of the oil film at one or more locations on the surface of the bluff body.

In others, the luminescence of the oil film is assessed using UV light. In yet other aspects, the method may further include assessing the surface pressure at various locations on the bluff body by using the relationship between skin friction and oil-film thickness, and skin friction and surface pressure.

Other aspects may include obtaining an image of the oil luminescence of the portion of the bluff body at one or more times. Others may include calculating the overall oil-film thickness from the image of the oil luminescence, and assessing the skin friction of the bluff body by using the relationship between skin friction and oil-film thickness.

Yet others may include extracting a snapshot solution of the skin friction field from two consecutive luminescent oil images. In others, the moving air has a velocity of about 6-73 m/s. in others, the oil has a viscosity of about 250 cSt. In yet others, the luminescent dye is oil-based and luminesces upon radiation with UV light. In others, the bluff body is selected from construction material, portion of a building, building model.

Embodiments of the present disclosure may include a system for assessing surface pressure generated by air moving across at least a portion of an bluff body surface, the system comprising: an oil film comprising a luminescent dye, wherein the oil film is capable of being uniformly spread in a thin film across a bluff body surface, wherein the oil film comprising a luminescent dye is capable of differential luminescence based on oil-film thickness; a wind tunnel capable of moving air at a uniform velocity and containing the at least a portion of a bluff body; an acquisition device to acquire luminescence data; and a light source capable of causing the luminescent dye to luminesce.

In yet others, the light source emits UV light. In others, the acquisition device is a digital camera. In some embodiments and aspects, the acquisition device may be any device capable of sensing and locating differences in luminescence intensity. In some, the device may be a digital camera. In others, image and/or light intensity and location data may be further processed using a data processor (i.e., a general computer or special purpose device) to compute relationships between light intensity, oil thickness, and skin friction as described more fully below.

In other embodiments, the digital camera can obtain two or more consecutive luminescent oil images to assess changes in luminescence over time. In yet others, the moving air has a velocity of about 6-73 m/s. In others, the oil has a viscosity of about 250 cSt. In others, the luminescent dye is oil-based and luminesces upon radiation with UV light.

### DESCRIPTION OF THE DRAWINGS

FIG. 1 depicts an example low-rise building model with corresponding dimensions;

FIG. 2 shows an experimental setup for GLOF measurements in an example aspect and embodiment of the current disclosure;

FIG. 3 depicts the raw image of a sample GLOF image made during testing using an example aspect and embodiment of the current disclosure;

FIG. 3B depicts a filtered image of a sample GLOF image using a long-pass filter of luminescent oil-film under UV excitation during testing using an example aspect and embodiment of the current disclosure;

FIG. 4A shows a top view of a sample GLOF image with superimposed skin friction vector fields in an example aspect and embodiment of the current disclosure;

FIG. 4B shows a ground view of a sample GLOF image with superimposed skin friction vector fields in an example aspect and embodiment of the current disclosure;

FIG. 4C shows a side view of a sample GLOF image with superimposed skin friction vector fields in an example aspect and embodiment of the current disclosure;

FIG. 5A depicts a top view of a normalized skin friction magnitude field with superimposed skin friction lines using an example aspect and embodiment of the current disclosure;

FIG. 5B depicts a ground view of a normalized skin friction magnitude field with superimposed skin friction lines using an example aspect and embodiment of the current disclosure;

FIG. 5C depicts a side view of a normalized skin friction magnitude field with superimposed skin friction lines using an example aspect and embodiment of the current disclosure;

FIG. 6A shows a top view of a normalized surface pressure magnitude field with superimposed skin friction lines in an example aspect and embodiment of the current disclosure;

FIG. 6B shows a ground view of a normalized surface pressure magnitude field with superimposed skin friction in an example aspect and embodiment of the current disclosure;

FIG. 6C shows a side view of a normalized surface pressure magnitude field with superimposed skin friction in an example aspect and embodiment of the current disclosure;

FIG. 7A depicts a 3D Mapped GLOF image with superimposed skin friction lines, from an example aspect and embodiment of the current disclosure;

FIG. 7B depicts a 3D Mapped normalized skin friction magnitude field from an example aspect and embodiment of the current disclosure;

FIG. 7C depicts a 3D Mapped normalized surface pressure from an example aspect and embodiment of the current disclosure.

### DETAILED DESCRIPTION OF THE INVENTION

The study of flow structures and characteristics around buildings has long been of significant interest to researchers. From an experimental perspective, skin friction and surface pressure measurements around bluff objects (i.e., bluff bodies) are crucial in the design and development of practical objects such as buildings and bridges. However, these are generally considered two of the most challenging surface quantities to measure experimentally.

Skin friction measurements are essential for understanding aerodynamic behavior as well as wind loads, which is of the outmost importance when optimizing designs in various applications, including buildings. Over the past decades, multiple local skin friction measurement techniques have been developed using local sensors (Aguiar-Ferreira et al. 2018; Boiko and Kornilov 2010). Nonetheless, due to their limited spatial resolution, most of these techniques are not really viable alternatives when studying global skin friction topological data.

At the same time, visual inspection of surface oil images has been commonly used to determine topological features such as separation and reattachment lines in complex separated flows (Furieri et al. 2012). However, visual examination is considered a purely quantitative approach and as a result topological features in complex flows are sometimes difficult to identify with accuracy. To overcome these limitations, a global luminescent oil-film (GLOF) skin friction meter was developed for the extraction of skin friction fields from luminescent oil images using the relationship between the thickness and the luminescent intensity of a thin oil-film doped with a luminescent dye (Liu et al. 2008; Liu 2019)

Just like skin friction, surface pressure is also a very critical parameter when trying to understand flow behavior and aerodynamic forces on a building. Pressure distribution data can be used to measure wind loads as well as uplift forces produced on a building during specific test conditions. Over the last several decades, a considerable amount of surface pressure data has been generated and comparisons made between experimental and numerical data. From an experimental point of view, most of the data collected was gathered using pressure taps, or local pressure transducers. This technique is relatively straightforward and accurate, which is why it is commonly used in both large wind tunnels in aerospace research facilities as well as universities (Liu and Sullivan 2005). Pressure taps provide high temporal resolution surface pressure data; however, their spatial resolution is extremely limited (one data point per sensor). Further, for complex test models, installation of pressure taps is not only a laborious task but also expensive. In addition, since pressure taps are local sensors, they are unable to provide surface pressure fields with high spatial resolution, which is required for global flow diagnostics in complex flows such as flow around buildings.

Alternatively, surface pressure measurements can be done using surface pressure sensitive paint (PSP), which is able to provide image-based non-contact, high-resolution, quantitative surface pressure based on the oxygen-quenching mechanisms of luminescence. PSP works well in compressible high-speed flows (freestream Mach number larger than 0.3) where oxygen concentration changes significantly, but in incompressible or low-speed flows (freestream Mach number less than 0.3), oxygen concentration changes are so small that the luminescence measurement of PSP results in a low signal-to-noise ratio (SNR). Therefore, high-resolution global surface pressure measurements in low-speed complex flows are still challenging (Liu and Sullivan 2005; Chen et al. 2019)

In the present disclosure, a very different approach for the extraction of surface pressure from skin friction in low-speed flows is proposed using the skin friction field extracted using the GLOF skin friction meter using the relation between surface pressure and skin friction derived from the Navier-Stokes (NS) equations. The following sections provide a more detailed description of the GLOF skin friction meter as well as the extraction of surface pressure from skin friction (Chen et al. 2019, Cai et al. 2022).

The GLOF skin friction meter is an image-based technique developed for the extraction of global skin friction data using the relationship between the thickness and the luminescent intensity of a thin oil-film doped with a luminescent dye (Liu et al. 2008; Liu and Sullivan 2005). Using this relation, the thickness of a thin oil-film on a solid surface is related to the skin friction, pressure gradient, gravitational acceleration and surface tension through the thin-oil-film equation:

$$\frac{\partial h}{\partial t} + \frac{\partial }{\partial {X}_{i}} ( \frac{{h}^{2}}{2 μ} {τ}_{i} - ( \frac{\partial {P}_{o}}{\partial {X}_{i}} - ρ {g}_{i} ) \frac{{h}^{3}}{2 μ} ) = 0 ( i = 1 , 2 ) \qquad ( 1 )$$

where h is the thickness of the oil-film, τi is the skin friction vector, μ is the dynamic oil viscosity, ρ is the oil density, gᵢ is the gravitational acceleration vector, and Xi are the corresponding object space coordinates on the surface plane, and Po represents the pressure at the oil-film.

Furthermore, h is proportional to the luminescent intensity/as given by I=aIₑₓh, where a is a coefficient proportional to the quantum efficiency of the seeded molecules and dye concentration and I and Iₑₓ are the image intensity and the intensity of the excitation light on the surface, respectively (Liu et al. 2008). By using image projection transformation, Eq. (1) can be written also written the image plane as given in Eq. (2):

$$\frac{\partial g}{\partial t} + ∇ \cdot ( g \overline{τ} ) = f \qquad ( 2 )$$

where g=I/Iₑₓ is the normalized luminescent intensity, ∇=∂/∂xi is the gradient operator, and τ-=τg(Δ/2 μa) is the equivalent skin friction where Δ is the scaling constant for image projection and it is considered a constant. The effects of pressure gradient ∂p/∂xi and the gravitational vector gi are given by Liu et al (2008):

$$f = λ \frac{\partial }{\partial {X}_{i}} ( λ ( \frac{\partial {P}_{o}}{\partial {X}_{i}} - ρ {g}_{i} ) \frac{{g}^{3}}{3 μ {a}^{2}} ) ( i = 1 , 2 ) \qquad ( 3 )$$

For a thin oil-film (h<<1), the effects of the pressure gradient, gravity and surface tension can be neglected as higher-order small terms such that the first-order approximation is f=0. By using a variational formulation similar to that used for optical flow computation, which is constrained by a smoothness regularization term, the following Euler-Lagrange equation is obtained (Liu et al. 2008):

$$g ∇ [ \frac{\partial g}{\partial t} + ∇ \cdot ( g \overline{τ} ) - f ] + α {∇}^{2} \overline{τ} = 0 \qquad ( 4 )$$

where the Neumann condition, ∂ [symbol] /∂n=0, is applied on the domain boundary and ∝ is the Lagrange multiplier.

The Euler-Lagrange equation given in Eq. (4) is numerically solved using a typical finite difference method by employing two consecutive GLOF images to obtain a snapshot field of [symbol] . A superposition scheme is then utilized to reconstruct a [symbol] field from a series of snapshot solutions in order to incorporate the spatial-temporal evolution history of the oil film and recreate a full steady-state skin friction field. This method yields a relative or normalized skin friction field without calibration (Liu et al 2008; Liu 2019). In situ calibration or other trustworthy experimental, computational, and/or theoretical methods are needed to get some correct values of skin friction at several places in order to calculate the unknown proportional coefficient in the relative skin friction field. Normalized skin friction fields are given in the examples herein without calibration, although calibration methods known in the art may be used.

The relation between surface pressure p and skin friction τ is derived from the NS equations in a general surface coordinate system (Chen et al. 2019; Cai et al. 2022). This on-wall relation is given by,

$$τ \cdot ∇ p = μ f Ω \qquad ( 5 )$$

where [symbol] is a virtual source term expressed as,

$${f}_{Ω} = {μ [ \frac{\partial Ω}{\partial n} ]}_{w} - μ {w}_{w} \cdot k \cdot {w}_{w} + {μ}_{θ} ( {w}_{w} Xn ) \cdot ∇ {θ}_{w} \qquad ( 6 )$$

where Ω=|ω|²/2 is the enstrophy, ∂/∂n is the derivative along the wall-normal direction, ω=∇×u is the vorticity, K is the surface curvature tensor, θ=∇·μ is the dilation rate, μ is the dynamic viscosity, μ₀=μ_{b}+4μ/3 is the longitudinal viscosity, μ_{b} is the bulk viscosity, and n is the unit normal vector of the surface (Chen et al. 2019; Cai et al. 2022). The subscript w denotes the on-wall quantities.

In order to solve the first-order differential equation representing the relation between surface pressure and skin friction given in Eq. (5), a variational formulation is proposed, which results in the Euler-Lagrange equation given by Chen et al. (2019):

$$τ \cdot ∇ ( τ \cdot ∇ p - Φ ) + ( τ \cdot ∇ p - Φ ) ∇ \cdot τ + α {∇}^{2} p = 0 \qquad ( 7 )$$

The approach presented in this work is based on the solution of the Euler-Lagrange equation, Eq. (7), when the source term Φ=μffl is given. However, in practical measurements in complex flows, the BEF (ffl) is not usually known, therefore, an approximation is required to close this open problem. The simplest approximation is to use a negative constant source term, i.e., Φ=const. (ffl=const.), since the BEF is generally negative except in some isolated regions such as critical points and separation/attachment lines (Cai et al. 2022). Hence, a relative (or normalized) surface pressure field is obtained by using the approximate method, where a proportional constant is to be determined by in-situ calibration using pressure tap data at several locations.

Although Φ could be an arbitrary negative constant, simulations indicate that the absolute value of Φ should be a suitable constant proportional to ∥τ·∇p∥₂ in order to achieve the good accuracy. It is important to mention that this approximation method is not applicable to the flow where the pressure gradient is uniformly zero in the whole field as a special case (Cai et al. 2022).

For a specific measurement, trial-and-error tests can be applied to select a suitable value of Φ. It is important to note that for a certain range, the extracted surface pressure field normalized by a reference value at a location is not very sensitive to the value of Φ (Cai et al. 2022).

Aspects and embodiments of the approach described herein extract relative pressure distribution, therefore, just like with the GLOF skin friction meter, in situ calibration or other trustworthy experimental, computational, and/or theoretical data is needed to get correct values of surface pressure at several places in order to calculate the unknown proportional coefficient in the relative pressure field. In this work, relative pressure fields are obtained without in situ calibration.

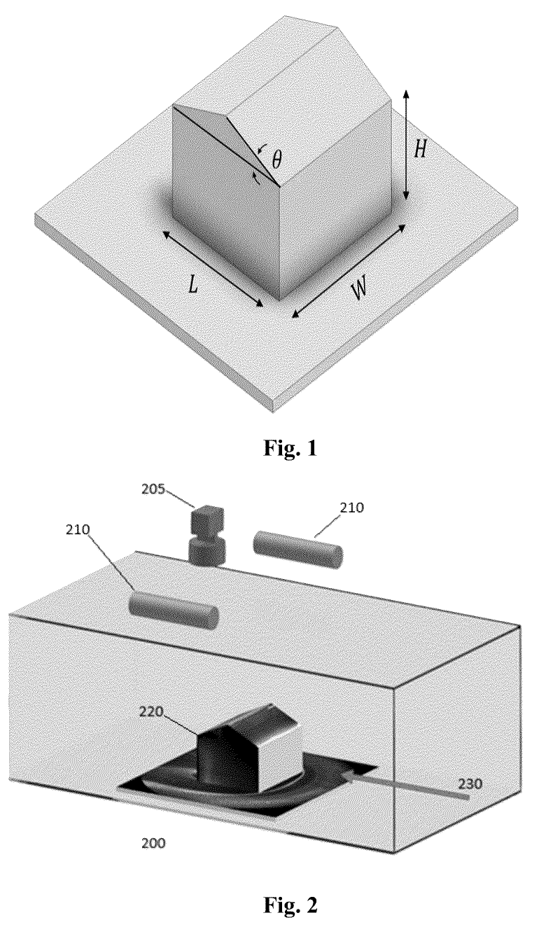

Example 1. For the purpose of this work, a generic 3D printed low-rise build model was used to demonstrate the effectiveness of the proposed technique. The model had reference length L of 200 mm, a width W of 230 mm, a frontal height H of 180 mm, and top slant angle θ of 26.2°. FIG. 1 shows the low-rise building model with the dimensions labeled.

All skin friction measurements were performed at Western Michigan University's Applied Aerodynamics Laboratory using the Advanced Design Wind Tunnel (ADWT). The ADWT is a low speed, closed circuit, atmospheric tunnel with a test section (0.8 meters high, 1.1 meters wide, and 2.4 meters long) with a freestream velocity range from 6 to 73 m/s. Clear windows on the top and side of the test section of the ADWT allow visual access during testing. The test model was mounted directly onto the ADWT's rotating turn table located in the ground of the test section, which allows 360 degree rotation. The blockage ratio was calculated at 6.3%. Testing was performed at a freestream velocity of 20 m/s corresponding to a Reynold number Rez of 2.43×10⁵.

In addition to the wind tunnel, the experimental setup required to perform skin friction measurements using the GLOF skin friction meter included a camera, UV lamps, image acquisition software and MATLAB processing codes.

GLOF images were collected from the top and side views using two Basler CCD cameras placed above and on the side of the ADWT test section. The luminescent oil mixture required for the GLOF technique was produced using a 250 cSt silicone oil mixed with a fluorescent-oil-based UV tracer dye (DFSB-K175 by Risk Reactor). The resulting luminescent oil emits the radiation at a longer wavelength due to the Stokes shift when illuminated by the UV lamps. The luminescent oil was brushed onto the test model using a foam brush and excited to luminescence by the UV lamps. In order to enhance the luminescent emission of the luminescent oil, all surfaces were coated with a white Mylar base layer. The wind tunnel was run in a dark environment, and GLOF images were captured using Basler Pylon software at a rate of 4 frames per second. In order to reconstruct the 3D skin friction and surface pressure distributions, images were collected from the top, the ground, and the side sections of the mode. A total of 720 images were collected for each section. The acquired images were then processed by using a specialized MATLAB code to extract skin friction fields.

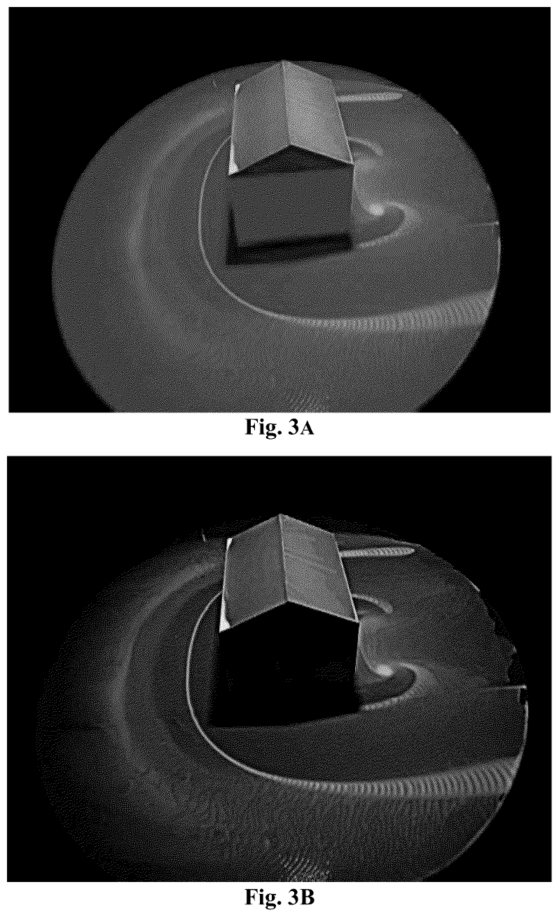

FIG. 2 shows a diagram of the experimental setup during GLOF measurements and FIG. 3 shows a sample image of the luminescent oil-film on the model during testing under UV excitation (a) raw image, and (b) filtered image using the long-pass filter. Referring to FIG. 2, experimental setup 200 may have CCD camera 205 and one or more UV lights 210 to visualize the luminescent oil covering test model 220. Air flow is direction in direction 230 to obtain the GLOF images (e.g. FIGS. 3a and 3b).

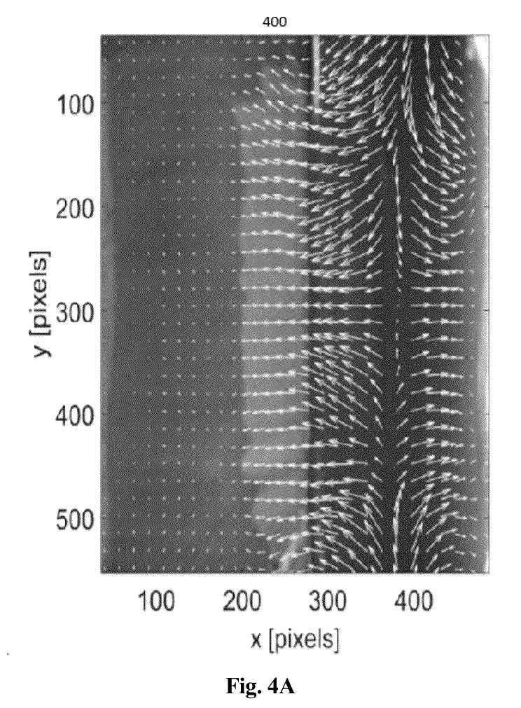

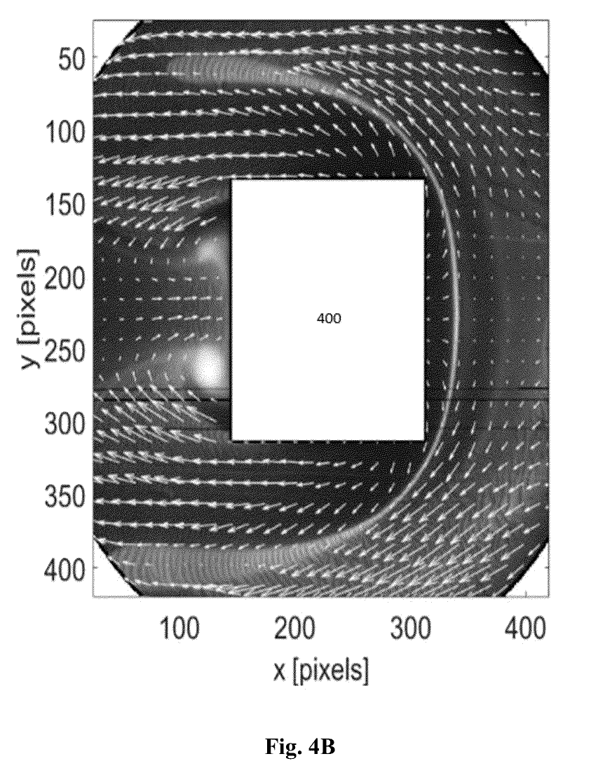

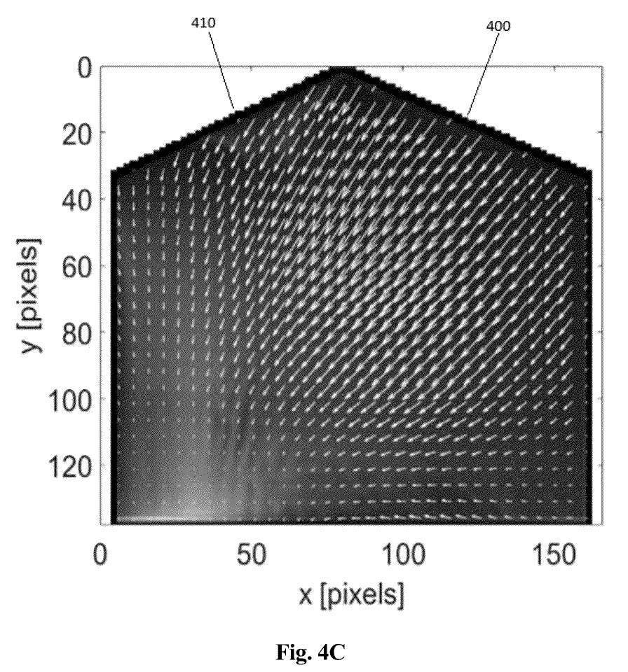

Example 2. The following example provides the results obtained using the approach previously described. It is noted that all the skin friction and surface pressure results are relative values normalized by the local maximum value in each surface. FIGS. 4(a)-(c) shows the sample GLOF image with superimposed skin friction vector fields of the (a) top (roof) of building 400, (b) at the ground level around building 400, and (c) on one side of building 400, with roof 410 labelled for reference.

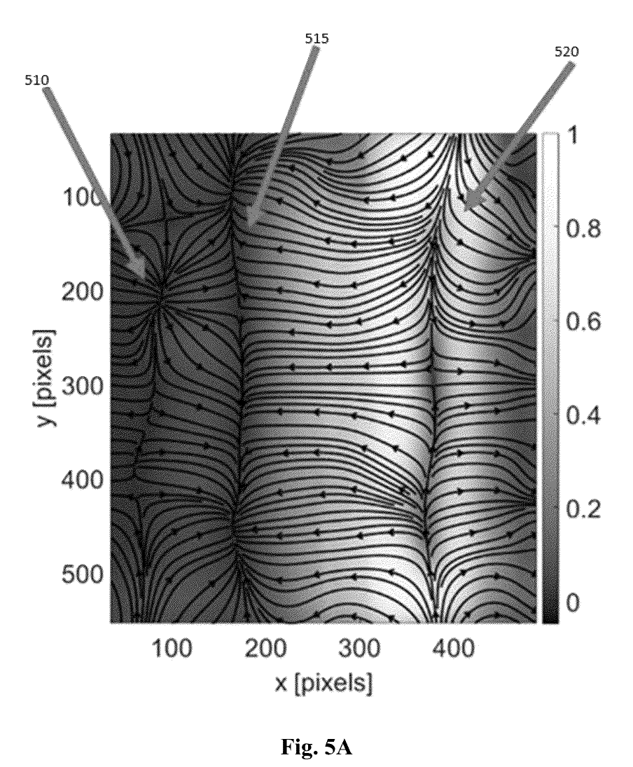

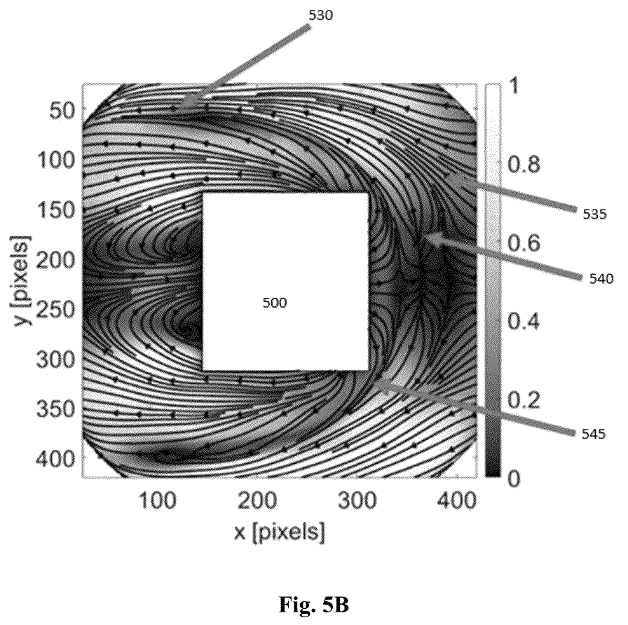

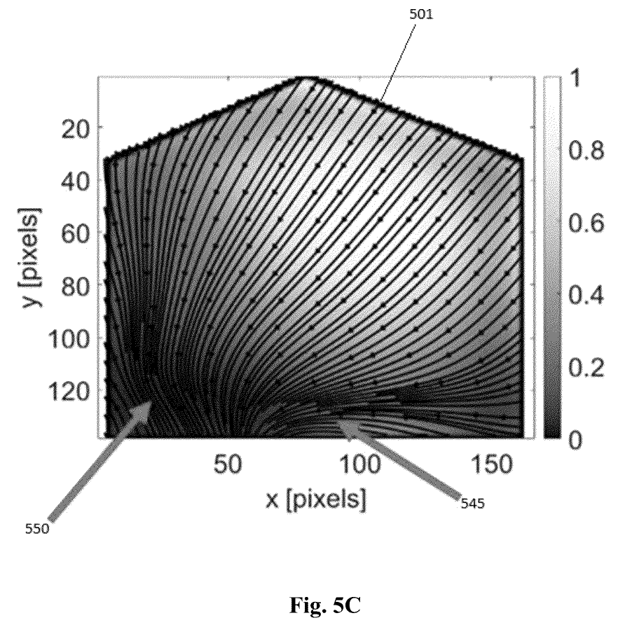

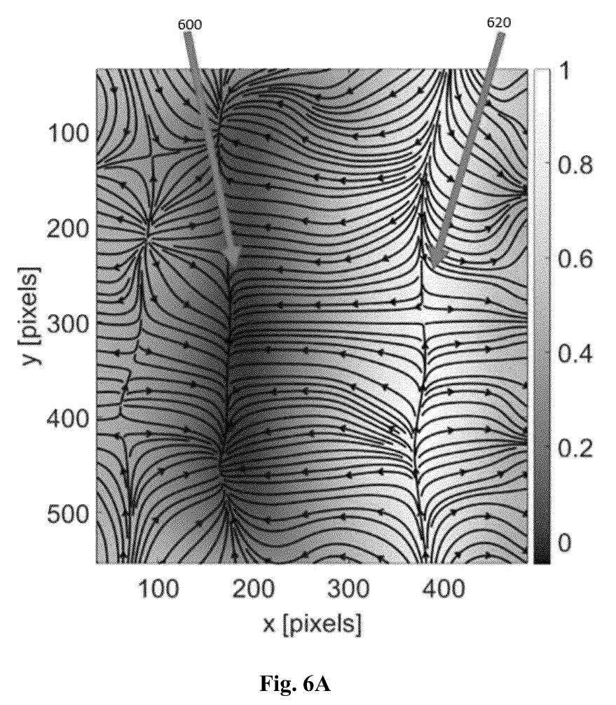

FIGS. 5(a)-(c) shows the normalized skin friction magnitude fields on the structure views shown in FIG. 4(a)-(c) with superimposed skin friction lines. Zones of secondary attachment 510, separation 515, and attachment 520 can be seen on the (a) roof of the structure, a horseshow vortex 530, separation 535, attachment 540, and secondary separation 545 at the (b) ground level of structure 500, and in (c), separation 550 and attachment 545 toward the bottom of the side of the structure, with roof 501 shown for reference.

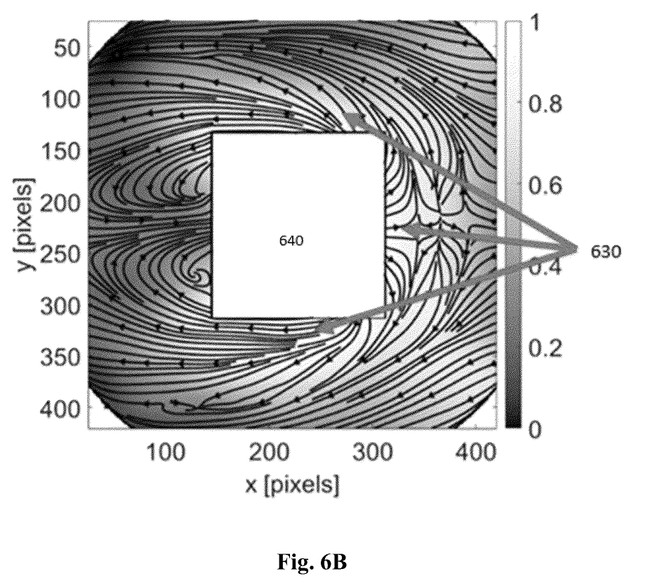

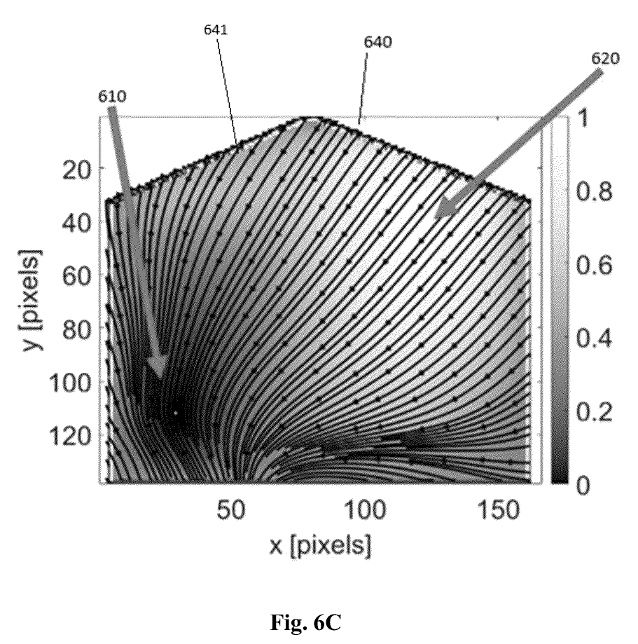

FIGS. 6(a)-(c) shows the normalized surface pressure magnitude fields with superimposed skin friction lines. On the roof shown in (a), low pressure 600 and high pressure 620 regions are observed. At the ground level in (b), high pressure regions 630 are seen. Finally, in side view oof house 640 (c), a high pressure region is seen at roof 641, with a low pressure region at 610.

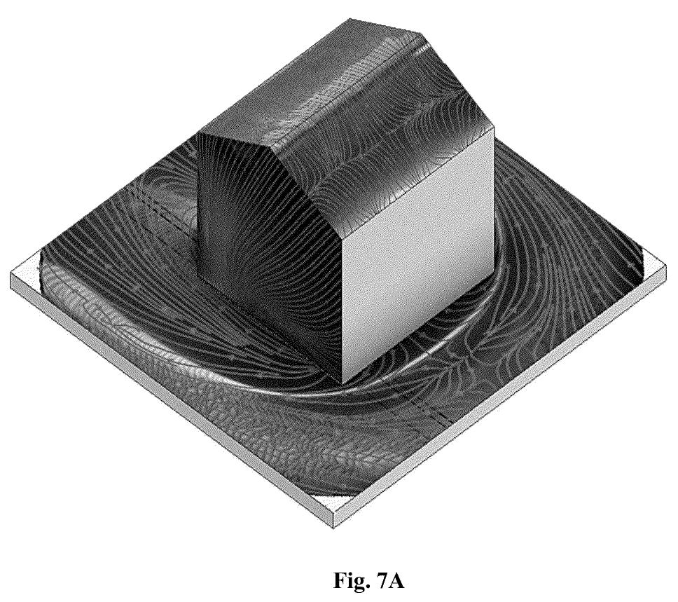

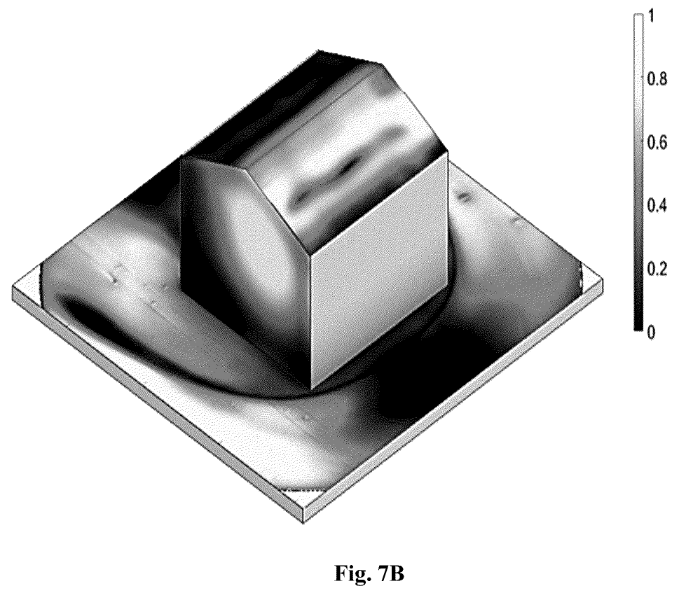

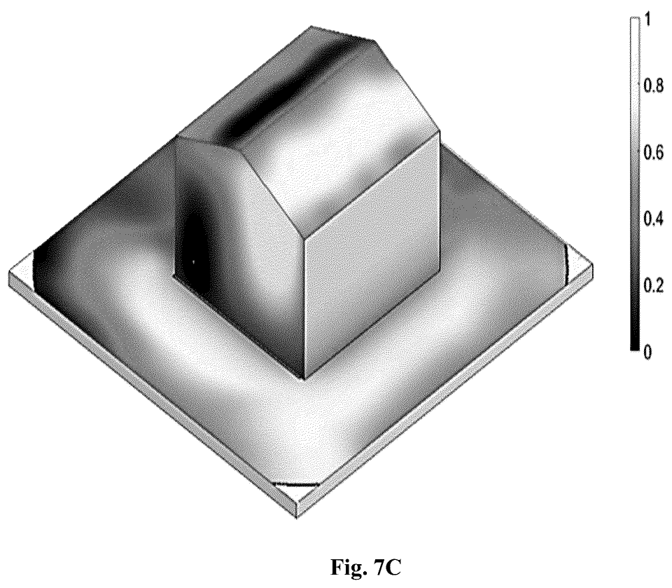

FIGS. 7(a)-(b) show the 3D Mapped GLOF image with (a) superimposed skin friction lines, (b) normalized skin friction magnitude field, and (c) normalized surface pressure.

As shown in FIGS. 4-7, a horseshoe structure in noticed in the ground plane around the test model, which is consistent with bluff body aerodynamic flow structures. This structure is accompanied by separation and reattachment lines. Here, an attachment line is a skin friction line from which neighboring skin frictions diverge, while a separation line is a skin friction line to which neighboring skin friction lines converge. In addition, from the surface pressure results, high and low surface pressure regions in and around the low-rise building model can also be observed.

The present disclosure descries aspects and embodiments for the extraction of skin friction and surface pressure data on buildings by using a global luminescent oil-film (GLOF) skin friction meter. The GLOF technique is derived by using the relation between skin friction and oil-film thickness given by the thin oil-film equation, which combined with a variational formulation, is able to extract global skin friction topological data. Surface pressure can then be extracted from the GLOF results by using the relation between surface pressure and skin friction given by the Navier-Stokes (NS) equations along with a variational formulation.

The proposed approach was successfully applied to a generic low-rise building model tested at Advanced Design Wind Tunnel (ADWT) at Western Michigan University's Applied Aerodynamics Laboratory (AAL). From the results obtained, skin friction and surface pressure data from the ground, sides, and top sections of the model, show clearly flow topological structures (i.e. flow separation and attachment) as well as high/low pressure regions. The data collected can be further used to evaluate aerodynamic forces and/or wind loads acting on the test model. This approach represents a very powerful image-based measurement technique for global skin friction and surface pressure fields on buildings, which is capable of extract high spatial resolution results (about one data point per pixel).

What is claimed is:

1. A method for assessing high resolution surface pressure fields generated by air moving across at least a portion of a bluff body, the method comprising
covering the at least a portion of the surface of the bluff body with a layer of oil film comprising a luminescent dye;
placing the bluff body in moving air with a constant velocity;
assessing the luminescence of the dye in at least two consecutive time periods,
wherein the luminescence of the dye is related to the thickness of the oil film at one or more locations on the surface of the bluff body.

2. The method of claim 1, wherein the luminescence of the oil film is assessed using UV light.

3. The method of claim 1, further comprising
assessing the surface pressure at various locations on the bluff body by using the relationship between skin friction and oil-film thickness, and skin friction and surface pressure.

4. The method of claim 1, further comprising obtaining an image of the oil luminescence of the portion of the bluff body at one or more times.

5. The method of claim 4, further comprising
calculating the overall oil-film thickness from the image of the oil luminescence, and
assessing the skin friction of the bluff body by using the relationship between skin friction and oil-film thickness.

6. The method of claim 5, further comprising
extracting a snapshot solution of the skin friction field from two consecutive luminescent oil images.

7. The method of claim 1, where the moving air has a velocity of about 6-73 m/s.

8. The method of claim 1, where the oil has a viscosity of about 250 cSt.

9. The method of claim 1, where the luminescent dye is oil-based and luminesces upon radiation with UV light.

10. The method of claim 1, wherein the bluff body is selected from construction material, portion of a building, building model.

11. A system for assessing surface pressure generated by air moving across at least a portion of an bluff body surface, the system comprising:
an oil film comprising a luminescent dye, wherein the oil film is capable of being uniformly spread in a thin film across a bluff body surface, wherein the oil film comprising a luminescent dye is capable of differential luminescence based on oil-film thickness;
a wind tunnel capable of moving air at a uniform velocity and containing the at least a portion of a bluff body;
an acquisition device to acquire luminescence data; and
a light source capable of causing the luminescent dye to luminesce.

12. The system of claim 11, wherein the light source emits UV light.

13. The system of claim 11, wherein the acquisition device is a digital camera.

14. The system of claim 13, wherein the digital camera can obtain two or more consecutive luminescent oil images to assess changes in luminescence over time.

15. The system of claim 11, where the moving air has a velocity of about 6-73 m/s.

16. The system of claim 11, where the oil has a viscosity of about 250 cSt.

17. The system of claim 11, where the luminescent dye is oil-based and luminesces upon radiation with UV light.
